(19) United States
(12) Patent Application Publication
(10) Pub. No.: US 2008/0226427 A1
(43) Pub. Date: Sep. 18, 2008

(54) APPARATUS FOR ACCURATELY POSITIONING AND SUPPORTING MODULAR TOOLING

(75) Inventor: Donald Van Zile, Clinton Township, MI (US)

Correspondence Address: YOUNG & BASILE, P.C., 3001 WEST BIG BEAVER ROAD, SUITE 624, TROY, MI, 48084, US

(73) Assignee: NORGREN AUTOMOTIVE, INC., Clinton Township, MI (US)

(21) Appl. No.: 12/105,403

(22) Filed: Apr. 18, 2008

Related U.S. Application Data
(63) Continuation-in-part of application No. 11/403,277, filed on Apr. 13, 2006.
(60) Provisional application No. 60/696,865, filed on Jul. 6, 2005.

(51) Int. Cl. B23Q 5/22

(52) U.S. Cl. 414/14; 414/800

(57) ABSTRACT

A tooling apparatus for securing and positioning an end effector tooling with respect to a workpiece. The tooling apparatus includes an elongated, substantially cylindrical backbone connectable to a manipulator and at least one saddle mount connected to the backbone. At least one primary arm mount is connected to the saddle mount, and at least one substantially cylindrical primary arm is connected to the primary arm mount. At least one tooling mount is connected to the at least one primary arm and is connectable to the end effector tooling.

The present application is a continuation-in-part of U.S. patent application Ser. No. 11/403,277, filed on Apr. 13, 2006, which claims priority to U.S. Provisional Patent Application No. 60/696,865, filed on Jul. 6, 2005.

### FIELD OF THE INVENTION

The present invention relates to an apparatus for accurately positioning and supporting modular tooling, and more particularly, an apparatus that provides a wide range of fine adjustment and rigid support for modular tooling to ensure accurate geometric positioning of a workpiece during machining and/or assembling of the workpiece.

### BACKGROUND OF THE INVENTION

The assembling and/or welding of various workpieces is often a challenging task in the manufacturing industry. For example, in the automotive industry, sheet metal stampings must often be welded together in order to create a single assembled or preassembled part. Prior to welding the sheet metal stampings, the stampings must be positioned in a highly accurate and repetitive geometric position in order that the sheet metal stampings may be accurately welded into an assembled position. Failure to do so may lead to the improper sizing and positioning of the assembled workpiece relative to the remaining parts of the automobile. The positioning of the sheet metal stampings prior to welding is often referred to as the geometric positioning of the workpiece.

In order to maintain the geometric positioning of the workpiece, previous designs have utilized heavy, rigid, structural members that are supported and moved by manipulators, such as robotic arms. These structural members are typically fabricated from heavy-duty steel so as to ensure the integrity and positioning of the end effector tooling that is mounted thereon. Such end effector tooling may include various power clamps, power grippers, and/or pin locators to locate and secure the workpiece in a predetermined geometric position. The adjustability and/or flexibility of the positioning and movement of the end effector tooling has been limited in such previous designs, as the previous designs typically concentrate on the rigidity and accuracy of the end effector tooling. This is to ensure that if the end effector tooling were to come into contact with something other than the workpiece, the end effector tooling will not be compromised, but rather, the end effector tooling will maintain the geometric positioning necessary to weld and assemble accurate workpieces.

The disadvantage to such previous designs is that they are typically heavy and non-flexible in design. Thus, the manipulator or robotic arm must be large and powerful enough to support and move such heavy tooling. In addition, the lack of flexibility does not allow for a high degree of adjustability to the end effector tooling such that the end effector tooling may be adjusted for a variety of different workpieces. The inability of such designs to adapt to various workpiece designs requires that the end effector tooling be dedicated to the specific configuration of one particular workpiece. This requires that a multitude of tooling be purchased and provided thereby creating an undesirable inefficiency in the industry.

It would be desirable to provide lightweight, flexible tooling that provided for the accurate positioning and support of end effector tooling to ensure the geometric positioning of a variety of workpieces during the machining and/or assembling of the workpiece.

### SUMMARY OF THE INVENTION

The invention provides an apparatus for accurately positioning, adjusting, and supporting end effector tooling to ensure proper geometric positioning of a workpiece during the machining and/or assembling of the workpiece. The tooling apparatus includes an elongated, substantially cylindrical backbone that is connectable to a manipulator. At least one saddle mount is connected to the backbone, and at least one primary arm mount is connected to the saddle mount. At least one substantially cylindrical primary arm is connected to the primary arm mount, and at least one tooling mount is connected to the primary arm and is connectable to the end effector tooling.

The saddle mount may have a substantially U-shaped configuration that includes a cap that is connected to the open end of the U-shaped configuration to close the open end of the U-shaped configuration. The saddle mount may also include at least one mounting surface for attaching the arm mount thereto. The U-shaped configuration and the cap cooperate to form a throughbore to receive and secure the backbone to the saddle mount. A dowel pin is connected to the saddle mount and extends into the throughbore to engage an aperture in the backbone for properly locating and securing the backbone with respect to the saddle mount. Furthermore, the cap of the saddle mount may include a plurality of threaded apertures adaptable to mount tooling hardware to the cap.

The apparatus may include a breakaway arm mount that is connected to the primary arm. The breakaway arm mount includes a weakened section that breaks upon realizing an impact to the primary arm that is greater than a predetermined level of force. The apparatus may further include a lock ring for connecting the primary arm to the saddle mount, wherein the lock ring provides radial and axial adjustment of the primary arm. The lock ring may include a pair of substantially similar semi-cylindrical discs that are connected together to form a bore extending therethrough for receiving the primary arm. Also, a locating pin may extend through the pair of semi-cylindrical discs and through a pair of apertures in the primary arm for properly locating and securing the primary arm to the pair of semi-cylindrical discs, wherein the locating pin has a longitudinal axis substantially perpendicular to the longitudinal axis of the primary arm. Additionally, the semi-cylindrical discs may include threaded apertures that extend substantially parallel to the longitudinal axis of the primary arm, wherein the threaded apertures allow the semi-cylindrical discs and the primary arm to be mounted in various rotational positions.

The apparatus may also include a transition mount that has a first substantially flat surface that is connected to the saddle mount and a second substantially flat surface that is connected to the primary arm mount, wherein the first surface and the second surface are disposed at acute angles with respect to one another.

A blade end mount may be provided having a pair of substantially similar semi-cylinders and a plate therebetween connected together to form a bore for receiving and securing the primary arm to the blade end mount. A dowel rod extends from the end mount into the bore and through an aperture provided in the primary arm for locating and securing the primary arm to the blade mount. Furthermore, the plate of the blade end mount may have a substantially flat mounting surface for mounting the end effector tooling substantially perpendicular to a longitudinal axis of the primary arm.

The apparatus may also include an end mount that has a pair of substantially similar semi-cylinders that are connected together to form a bore for receiving and securing the primary arm, wherein a dowel rod extends from the end mount into the bore and through an aperture that is provided in the primary arm for locating and securing the primary arm to the end mount. Furthermore, the end mount has a substantially planar surface that is connected to the pair of semi-cylinders and extends substantially perpendicular to the longitudinal axis of the primary arm for mounting the end effector tooling thereto. Furthermore, the substantially planar surface of the end mount may have a plurality of adjacent apertures linearly aligned, and a pair of slots extending therethrough.

The apparatus may further provide an accessory clamp that has a flexible band formed in a substantially U-shaped configuration, wherein the ends of the U-shaped configuration are connected to a bracket. Furthermore, the bracket may have threaded apertures that are connectable to tooling hardware. Additionally, a cable tray having a hollow, substantially rectangular configuration may be connected to the bracket.

The apparatus may also include a secondary arm mount. The secondary arm mount has a first throughbore for receiving the primary arm. A dowel pin extends from the secondary arm mount into the throughbore and through an aperture in the primary arm to properly position and secure the primary arm to the secondary arm mount. The secondary arm mount also has a second throughbore for receiving a secondary arm. A dowel pin extends from the secondary arm mount into the second throughbore and through an aperture in the secondary arm to properly position and secure the secondary arm to the secondary arm mount. Furthermore, the secondary arm mount has a substantially flat mounting surface that is connectable to the end effector tooling.

### BRIEF DESCRIPTION OF THE DRAWINGS

The description herein makes reference to the accompanying drawings wherein like reference numerals refer to like parts throughout several views and wherein:

FIG. 1 is a perspective view of the apparatus of the present invention being utilized to clamp and position two sheet metal workpieces;

FIG. 2 is a perspective view of the apparatus of the present invention clamping and positioning a sheet metal workpiece;

FIG. 3 is a perspective view showing the apparatus of the present invention locating and clamping two sheet metal pieces;

FIG. 4 is a perspective view of the apparatus of the present invention in another configuration;

FIG. 5 is a front plan view of a rigid support member of the apparatus of the present invention;

FIG. 6 is a perspective view showing the rigid support member, the coupling members, and the support member of the apparatus of the present invention;

FIG. 7 is a perspective view showing an adjustable support member of the apparatus of the present invention;

FIG. 8 is a cross-sectional view taken on line 8-8 of FIG. 5;

FIG. 9 is a perspective view of an apparatus of an additional embodiment of the present invention being utilized to clamp and position a workpiece;

FIG. 10 is a perspective view of a first saddle mount;

FIG. 11 is a perspective view of a second saddle mount;

FIG. 12 is a perspective view of a third saddle mount;

FIG. 13 is a side view of a primary arm mount connected to a primary arm;

FIG. 14 is a perspective view of a breakaway arm mount of the primary arm mount;

FIG. 15 is a perspective view of a lock ring disposed on the primary arm;

FIG. 16 is a front view of the lock ring disposed on the primary arm;

FIG. 17 is a side view showing a secondary arm mount;

FIG. 18 is a perspective view showing the second arm mount;

FIG. 19 is a top view showing a blade end mount;

FIG. 20 is a perspective view showing the blade end mount;

FIG. 21 is a side view showing an end mount;

FIG. 22 is a end view showing the end mount;

FIG. 23 is a perspective view showing the end mount;

FIG. 24 is a perspective view showing a first blade mount connected to the end mount;

FIG. 25 is a perspective view showing a second blade mount connected to the end mount;

FIG. 26 is a perspective view showing a transition mount;

FIG. 27 is a perspective view showing an accessory clamp; and

FIG. 28 is a perspective view showing a plurality of cable trays attached to the backbone using the accessory clamp.

### DESCRIPTION OF THE PREFERRED EMBODIMENT

Referring to the drawings, the present invention will now be described in detail with reference to the disclosed embodiment.

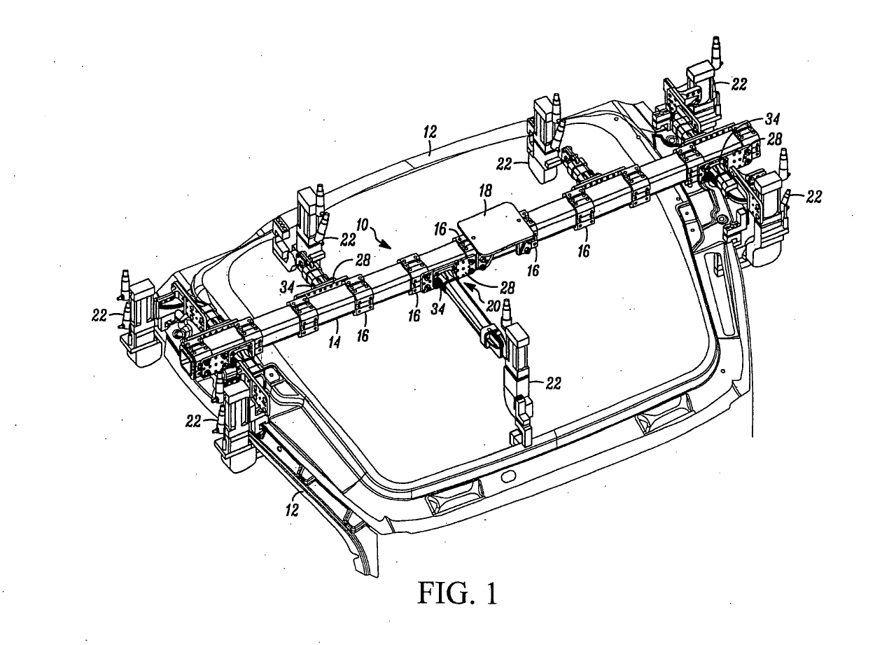

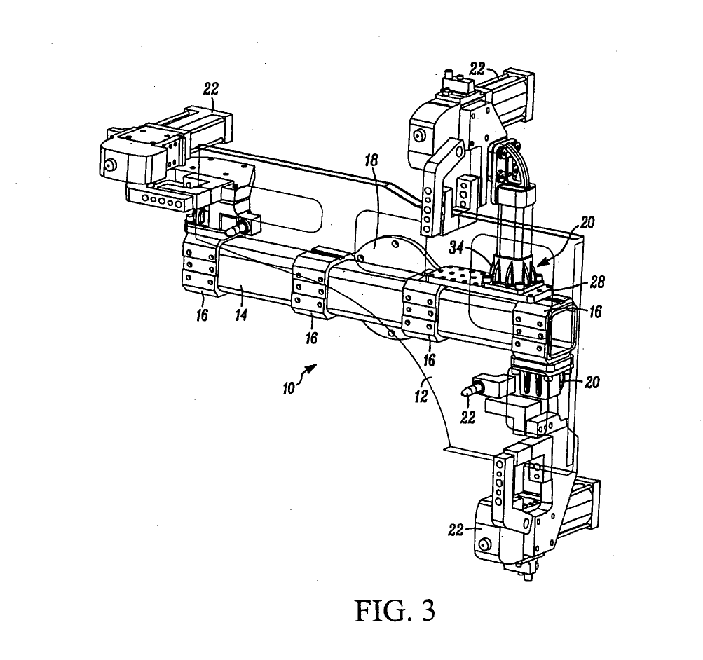

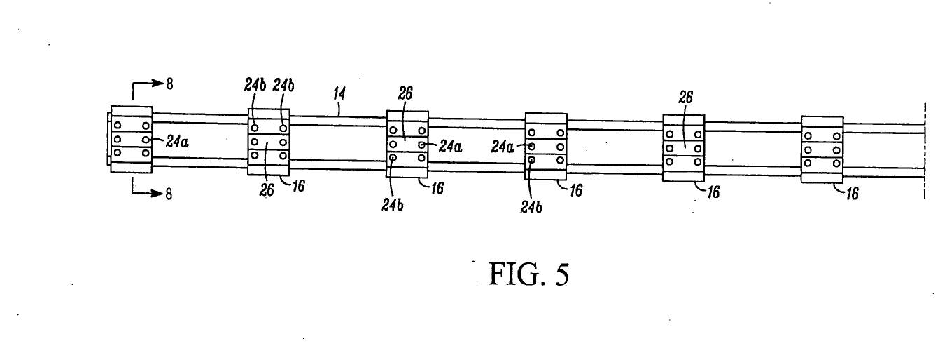

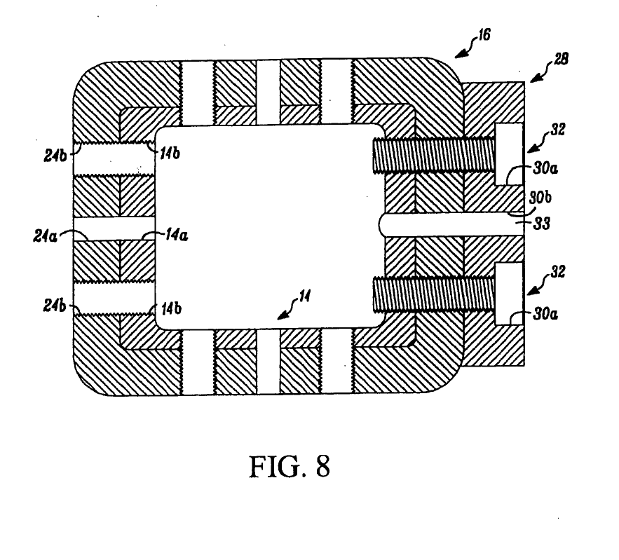

FIGS. 1-8 illustrate an apparatus 10 for accurately positioning and supporting a workpiece 12 or workpieces 12, such as stamped sheet metal parts, in a predetermined geometric position so that certain machining and assembling operations may be performed on the workpiece 12.

The apparatus 10 includes a rigid support member or backbone member 14 that is connectable to a manipulator, such as a robotic arm (not shown). The backbone member 14 has a plurality of annular coupling or collar members 16 mounted thereon in predetermined longitudinally spaced positions. A mounting plate 18 may be connected to a pair of collar members 16 whereby the manipulator or robotic arm is connected via the mounting plate 18 to the backbone member 14. A plurality of support structures 20 are connected to at least one of the collar members 16 in predetermined positions. The support structures 20 support end effector tools 22, such as a power clamps, power grippers, and/or a locator pins. The apparatus 10 provides accurate positioning of the end effector tools 22 so as to accurately and repeatably position the workpieces 12 in a predetermined geometric position so that a particular machining or assembling operation, such as welding, may be performed on the workpieces 12. Such geometric positioning may hold tolerances up to + or −0.25 mm

In order to provide the apparatus 10 with the appropriate rigidity and support, the backbone member 14 is fabricated from a substantially rectangular, hollow tubular structure having rounded corners thereon. The backbone member 14 is fabricated from a lightweight, high-strength rigid material, such as carbon fiber, steel, castings, aluminum, or other lightweight, high-strength, rigid materials. The backbone member 14 is fabricated in a high-precision manner such that the backbone member 14 may maintain a high degree of accuracy.

The collar members 16 are mounted on the outside surface of the backbone member 14. The collar members 16 are substantially rectangular and hollow so as to receive the backbone member 14. The collar members 16 are also fabricated from a lightweight, high-strength material, similar to that provided for the backbone member 14. The collar members 16 are fixedly secured to the backbone member 14 by bonding or welding. However, it is anticipated that other securing means may be utilized such as expanding the backbone member 14 onto the collar members 16 when the backbone member is fabricated from a carbon fiber material.

Following securement of the collar members 16 on the backbone member 14 in predetermined longitudinally spaced positions, six apertures, formed as two parallel rows, are machined in each of the four sides of each collar member and in the underlying backbone member for receiving dowel rods 33 and threaded fasteners 32 from the support structures 20. The central apertures 24a on each row on each side of the collar member 16, as well as the aligned central apertures 14a in backbone member 14, are unthreaded and receive a dowel rod 33, and the outboard apertures 24b in each row on each side of the collar member 36, as well as the aligned outboard apertures 14b in backbone member 14, are threaded for receiving threaded fasteners 32. Each of the four sides of the collar members 16 may also have a recessed portion 26 for reducing the amount of material and weight associated with the collar members 16. Again, the collar members 16 are fabricated in a high-precision manner so as to maintain a high degree of accuracy when mounting the end effector tooling 22 thereon.

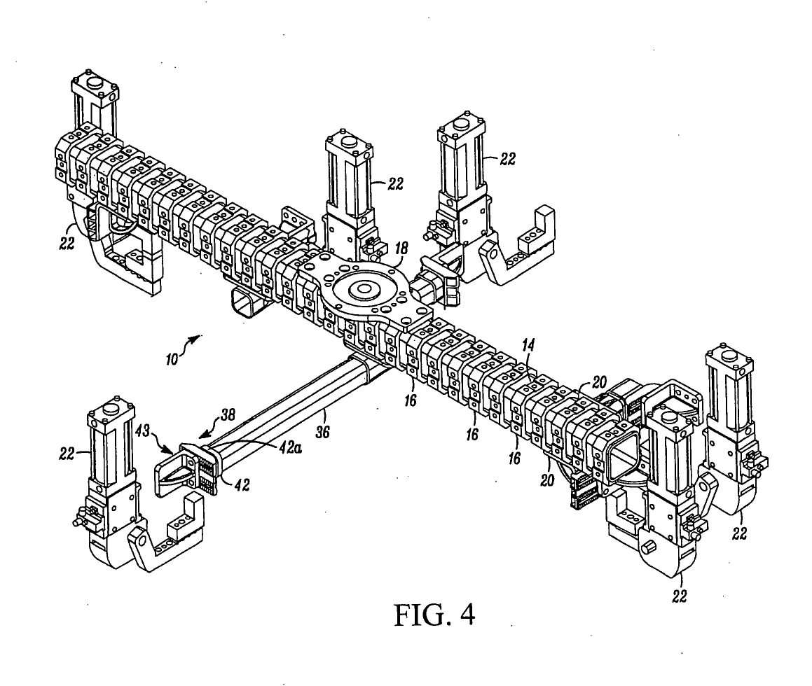

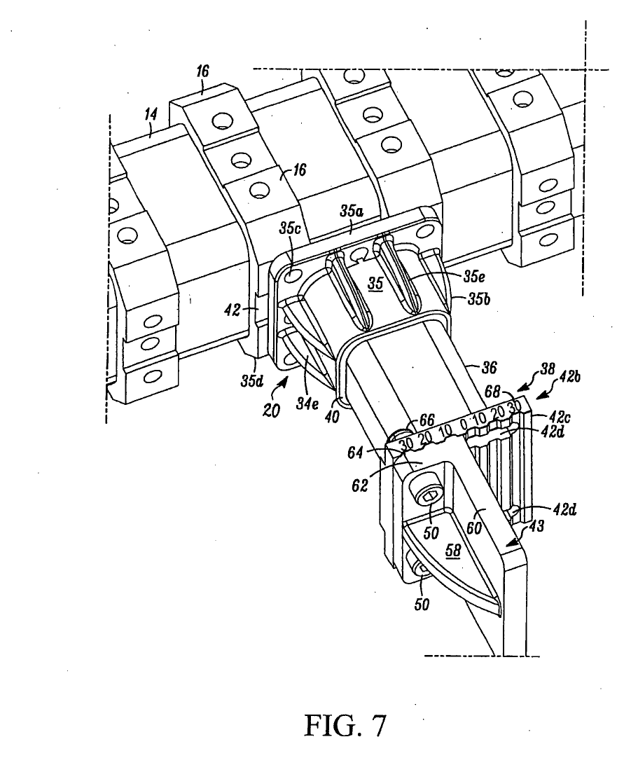

Alternatively, and as seen in FIGS. 4 and 7, each collar member 16 may have a single row of apertures 24a, 24b on each side thereof for aligned coaction with a single row of apertures in the underlying backbone member 14.

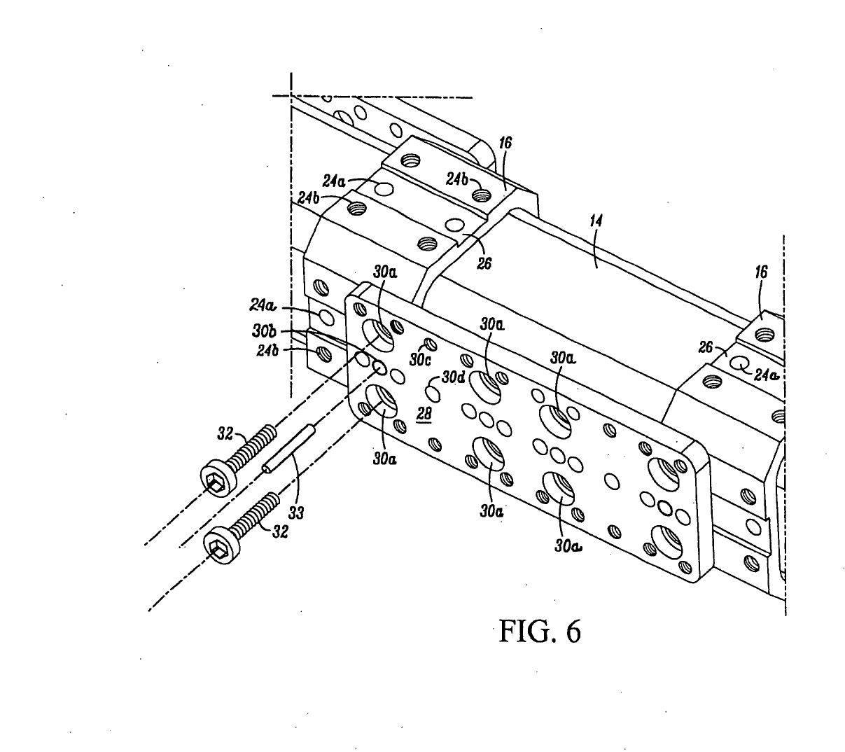

Various support structures 20 may be utilized to connect the end effector tooling 22 to the collar members 16. In one support structure embodiment, seen in FIGS. 1, 3 and 6, the support structure includes a support plate 28 connected to and extending between a pair of collar members 16, as best seen in FIG. 6. The support plate 28 may be connected at each end to any of the four sides of the collar members 16. The support plate 28 has a substantially rectangular, plate-like configuration with rounded corners. A plurality of unthreaded outboard counterbore apertures 30a extend through the support plate 28 for receiving headed threaded fasteners 32 for engagement with threaded apertures 24b in a side face of the collar members and aligned threaded apertures 14b in the backbone member, and a plurality of unthreaded central constant diameter apertures 30b extend though the support plate for receiving locating dowel rods 33 for receipt in unthreaded central apertures 24a in a side face of the collar members and aligned unthreaded central apertures 14a in the backbone member. The threaded fasteners 32 serve to rigidly mount the support plate 28 on the collar members 16 and the dowel rods 33 provide a high degree of locational accuracy in the positioning of the plate on the collar members. The support plate 28 further includes a plurality of spaced rows of apertures with each row including a pair of threaded outboard apertures 30c and an unthreaded central aperture 30d. The support plate 28 is manufactured in a highly precise manner and may be fabricated from a low weight, high strength rigid material similar to that provided for the rigid support member 14. The support plate 28 allows for adjustment of the end effector tooling 22 along a longitudinal axis of the backbone member 14.

The support structure 20 of the embodiment of FIGS. 1, 3 and 6 also includes a socket member 34 that is connected directly to the support plate 28 by the use of conventional fasteners 32 engaging threaded outboard apertures 30c and locating dowel rods 33 engaging unthreaded central apertures 30d.

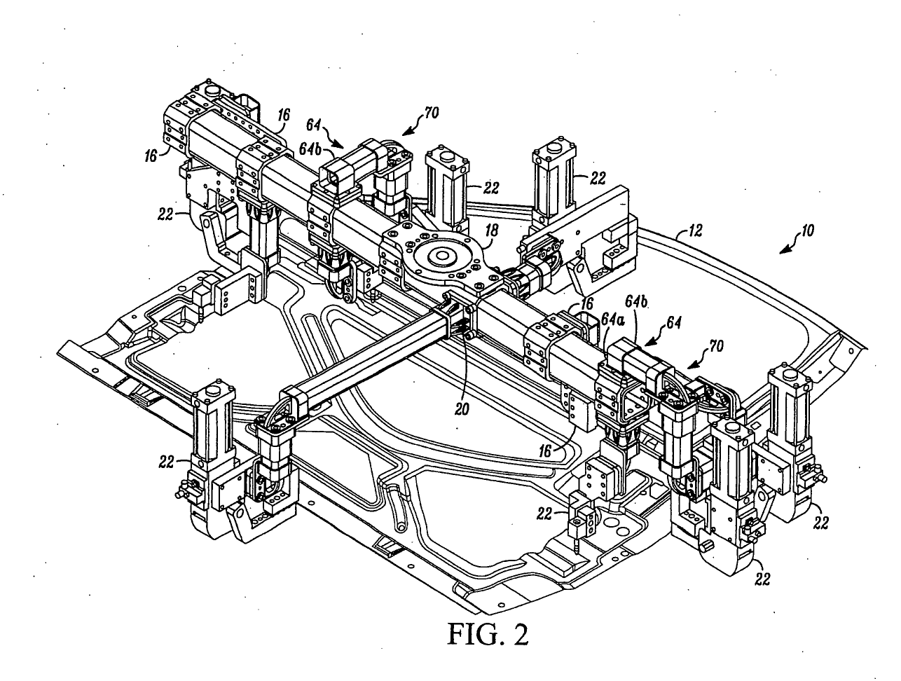

In an alternate embodiment of support structure 20, as seen in FIGS. 2 and 7, the support structure 20 may comprise a unitary member 35 including a rectangular base portion 35a and a rectangular socket portion 35b. Base portion 35a includes outboard apertures 35c extending therethrough for receiving conventional fasteners 32 for threaded engagement with outboard collar apertures 24b and outboard backbone apertures 14b and central constant diameter apertures 35d for receiving dowel rods 33 for receipt in unthreaded central collar apertures 24a and unthreaded central backbone apertures 14a. Rib portions 34e extend integrally from the base portion 35a and the tubular portion 35b to provide added support to the tubular portion 35b. Unitary member 35 is manufactured in a highly precise manner and may be fabricated from a low weight, high strength rigid material similar to that provided for the rigid support member 14.

In a further alternate embodiment of the support structure 20, seen at 64 in FIG. 2, the support structure includes a base plate portion 64a secured to a side face of a collar and a U-shaped tubular socket portion 64b.

The positioning apparatus of the invention further includes a plurality of boom rods 36. Each boom rod 36 is substantially rectangular and hollow and includes rounded corners. Each boom rod 36 is telescopically received at its inboard end in a socket column member 34, in a socket portion 35b of a unitary member 35, or in the “U” shaped socket portion 64b of a support structure 64, and may be fixedly secured to the member 34, socket portion 35b, or socket portion 64b by bonding or welding. Each boom rod 36 is also manufactured in a highly precise manner and fabricated from a light weight, high strength rigid material as previously described for the rigid support member 14.

As best seen in FIGS. 4 and 7, each effector tooling 22 is supported on the outboard end of a boom rod 36 through the use of an adjustable coupling. Several variations of adjustable couplings are illustrated. One form of adjustable coupling is seen at 38 in FIGS. 4 and 7 and includes a base member 42 and an adjustable mounting plate 43.

Base member 42 includes a substantially rectangular tubular portion 42a for telescopically receiving the outboard end of a boom rod 36 and a base portion 42b which is integral with the tubular portion 42a. The base portion 42b provides a substantially flat mounting surface having contoured parallel grooves 42c formed therein. A pair of spaced substantially parallel slots 42d extend through the base portion 42b of the base member 42 at right angles to the grooves 42c.

Each adjustable mounting plate 43 is coupled to the base portion 42b of a base member 42. The adjustable mounting plate 43 has an L-shaped configuration including a webbed portion 58 extending integrally between a long leg portion 60 and a short leg portion 62. The short leg portion 62 has a contoured ribbed surface 64 formed on the bottom thereof for matingly engaging the grooves 42c on the base portion 42b of the base member 42 whereby to adjustably mount the mounting plate on the base member. A pair of apertures extend through the short leg portion 62 of the mounting plate 43 and align with the slots 42d in the base portion 42b of the base member 42. A pair of conventional fasteners 50 extend through the apertures in the leg portion 62 and through the slots 42d, and a nut 66 is provided on the threaded end of the fasteners 50 to tighten the mounting plate 43 on the base member 42 in any desired position of lateral adjustment. Indicia 68 are provided on an edge of the base portion 42b of the base member 42 so as to indicate the position of the adjustable mounting plate 43 relative to the base member. Each adjustable coupling 38 is manufactured in a highly precise manner and fabricated from similar materials as the rigid support member 14.

Each end effector tooling 22 is mounted on an adjustable mounting plate 43 utilizing apertures extending through the adjustable mounting plate which correspondingly align with apertures provided in the end effector tooling 22. Conventional fasteners extend through the apertures in the adjustable mounting plate 43 and into the apertures provided in the end effector tooling 28 to secure the end effector tooling 22 to the adjustable mounting plate 43. As previously noted, various end effector tooling 22 may be utilized, such as power grippers, power clamps, locator pins, etc.

In operation, the apparatus 10 is typically set up prior to connecting the apparatus 10 to a manipulator or a robotic arm. The end effector tooling 22 is adjusted with respect to the apparatus 10 so as to provide proper geometric positioning of the workpiece 12. The end effector tooling 22 may be adjusted by moving and/or adjusting the collar members 16 with respect to the backbone member 14 and by adjusting support structures 20 with respect to collar members 16. The length of the boom rods 36 may also be adjusted to provide further adjustment to the end effector tooling 22. The adjustable mounting plate 43 also provides varied adjustment of the end effector tooling 22. Further, as seen at 70 in FIG. 2, combinations of boom rods and couplings may be utilized to allow the mounting structure for the end effector tooling to include right angles or elbows.

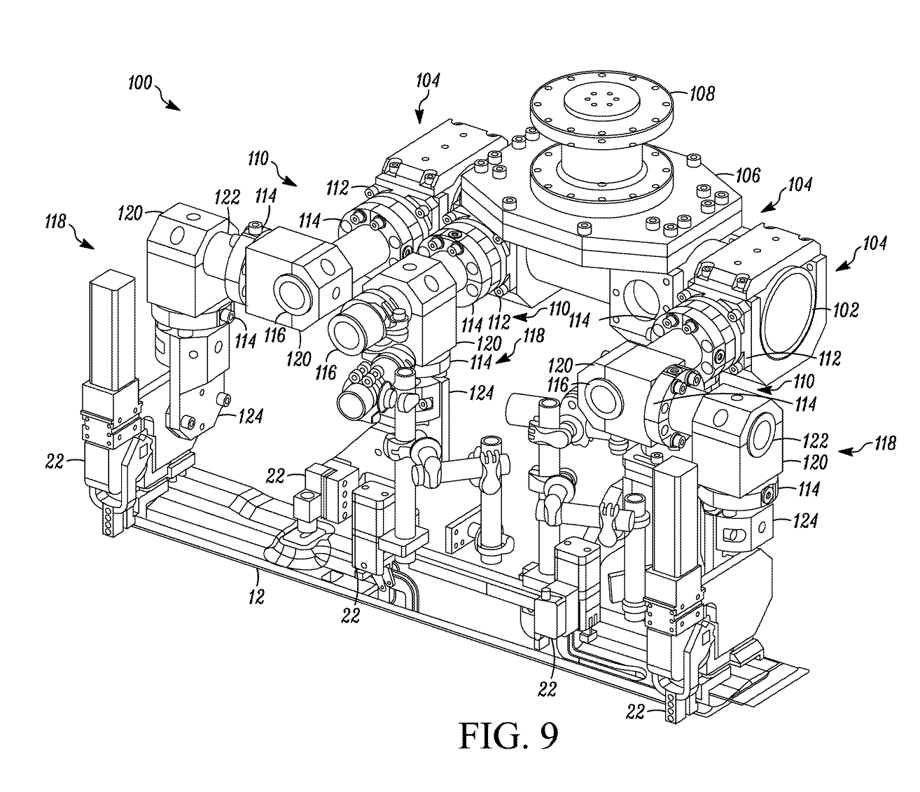

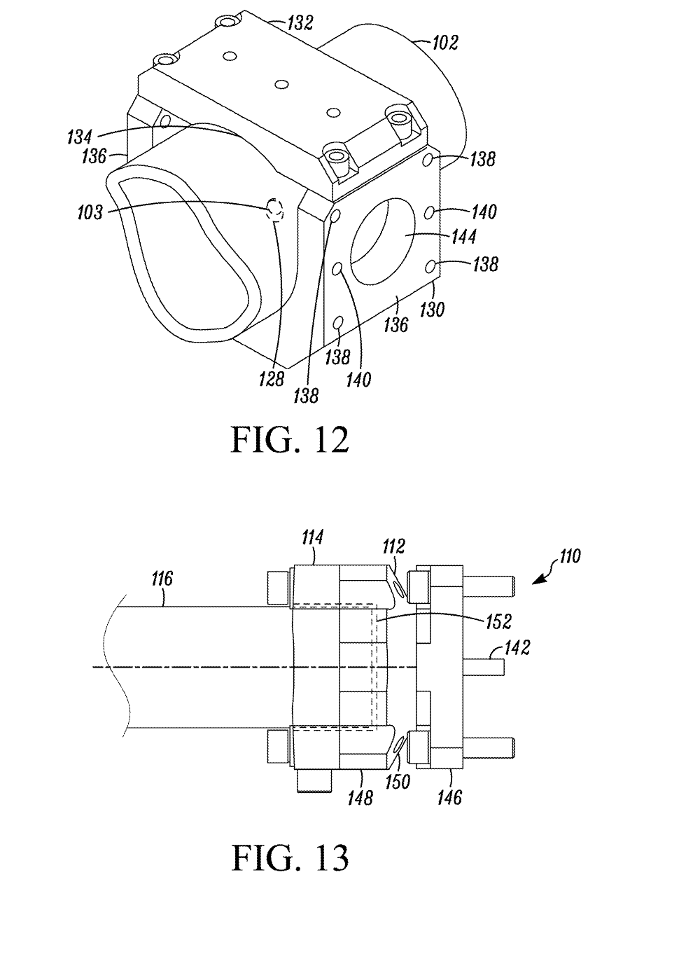

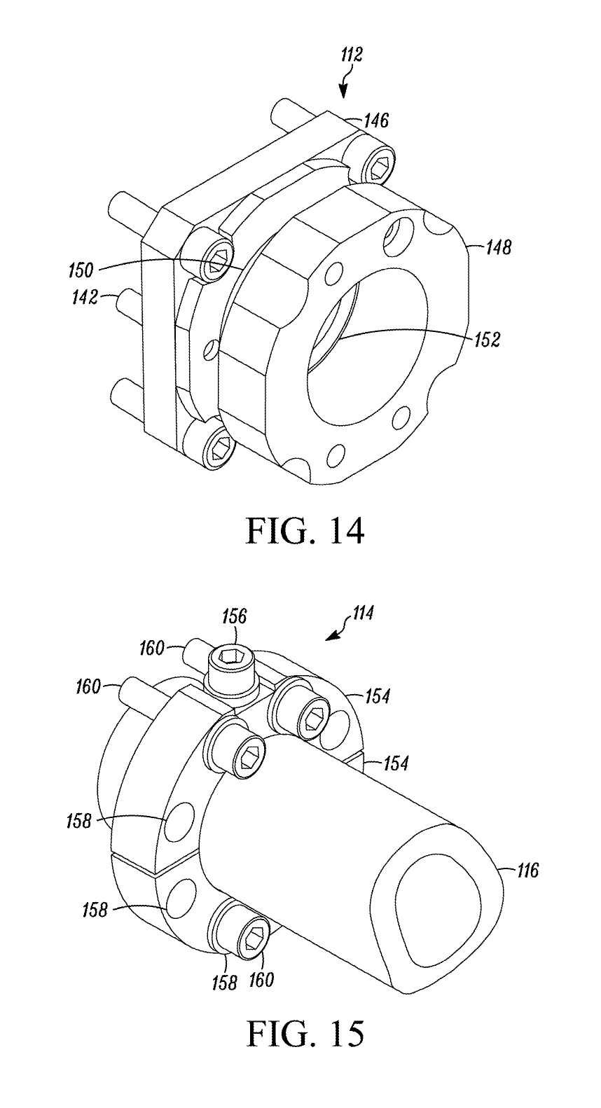

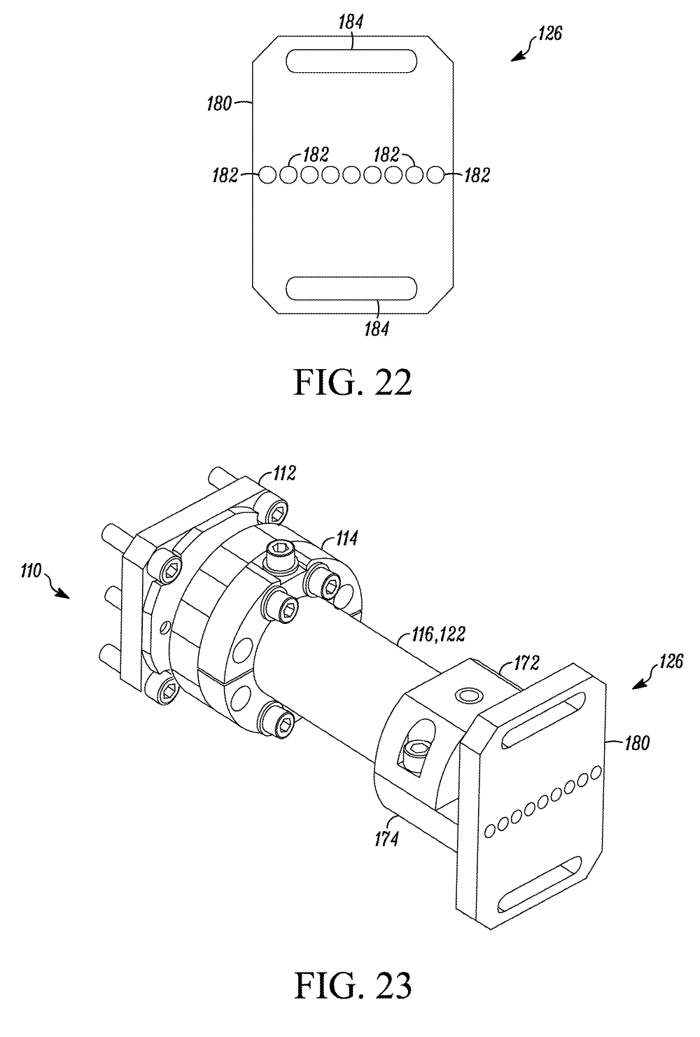

In an additional embodiment, an apparatus 100 for accurately positioning and supporting a workpiece 12, such as stamped sheet metal parts, in a predetermined geometric position so that certain machining and assembling operations may be performed on the workpiece 12, as shown in FIGS. 9-28.

The apparatus 100 includes a rigid, elongated, substantially cylindrical support member or backbone member 102. The backbone 102 may have at least one saddle mount 104 connected to the backbone in predetermined longitudinally-spaced positions. Either the backbone 102 or a portion of the saddle mounts 104 may be connectable to a manipulator, such as a robotic arm (not shown). A mounting plate 106 may be connected to the saddle mounts 104, whereby the manipulator or robotic arm is connected via the mounting plate 106 to the backbone member 102. The mounting plate 106 may have a fixture 108 mounted thereon for allowing for easy engagement with the manipulator or robotic arm. At least one primary arm mount 110 may be connected to at least one of the saddle mounts 104. Each primary arm mount 110 may include a breakaway arm mount 112, which will be described in further detail later in the specification, and the primary arm mount 110 may also include a lock ring 114, as will also be described in further detail later in the specification. A substantially cylindrical and rigid primary arm 116 may extend from the primary arm mount 110, wherein a tooling mount 118 may be connected to the primary arm 116. The tooling mount 118 may include a secondary arm mount 120, which connects to the primary arm 116 and is connected to a secondary arm 122, which is similar to the primary arm 116. The tooling mount 118 may also include a blade end mount 124, which may be connected to the primary arm 116 or the secondary arm 120 and further provides a mounting surface for mounting end effector tools 22. In addition, the tooling mount 118 may include an end mount 126, which may also be connected to the primary arm 116 or the secondary arm 120 while also providing a planar mounting surface for connecting the end effector tooling 22 thereto. Through the use of the above-noted apparatus, the end effector tooling 22 can accurately position and support a workpiece 12 for the appropriate machining and assembling of the workpiece 12.

In order to provide the apparatus 100 with the appropriate rigidity and support, the backbone member 102 is fabricated from an elongated, substantially cylindrical hollow structure. The backbone 102 may be fabricated from a lightweight, high-strength, rigid material, such as carbon fiber, steel, castings, aluminum, or other lightweight, high-strength, rigid materials. The backbone 102 is fabricated in a high-precision manner such that the backbone 102 may maintain a high degree of accuracy. The backbone 102 may have a plurality of apertures 103 extending therethrough for receiving dowel pins 128 from the saddle mounts 104 for properly locating and positioning the backbone 102 relative to the saddle mounts 104.

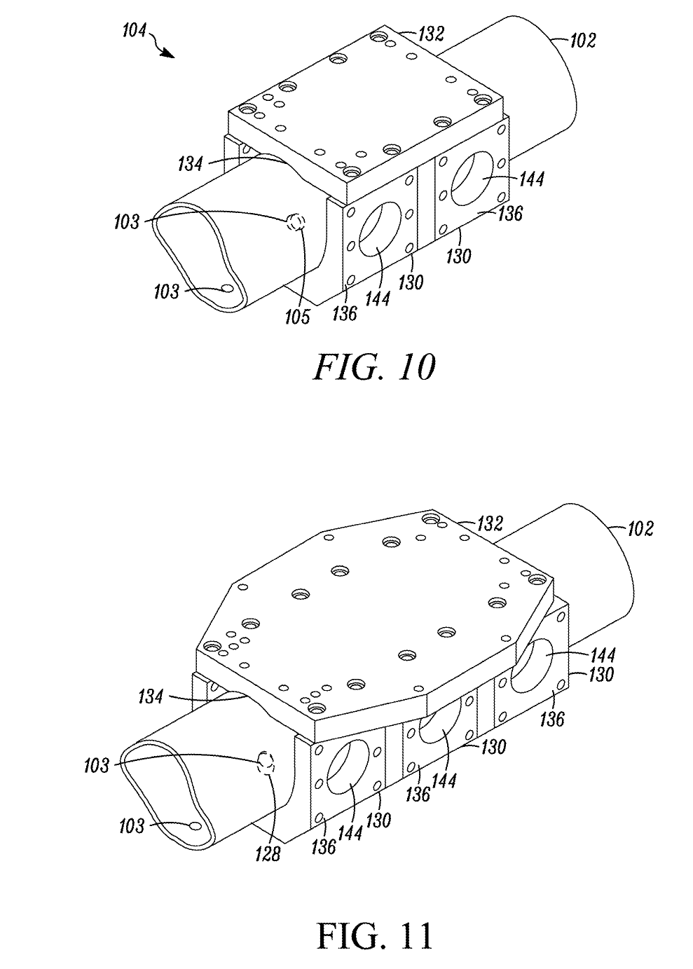

In order to secure the end effector tooling 22 to the backbone 102, the apparatus 100 provides the saddle mounts 104, as best seen in FIGS. 10-12. Each saddle mount 104 has a substantially U-shaped configuration 130 with a cap 132 connected to the open ends of the U-shaped configuration 130, thereby closing the opening of the U-shaped configuration 130 of the saddle mount 104. Various caps 132 may be utilized depending on the number of U-shaped configurations that are utilized in the saddle mounts 104. The U-shaped configuration 130 and an arcuate recess 134 in the underside of the cap 132 of the saddle mount complementarily receive the backbone 102 of the apparatus 100. The dowel pin 128 extends from the inside of the U-shaped configuration 130 of the saddle mount 104 and engages the aperture 103 provided in the backbone 102. The dowel pin 128 provides accurate and proper positioning of the backbone 102 relative to the saddle mount 104. Each U-shaped configuration 130 of the saddle mount 104 provides a pair of flat mounting surfaces 136 for connecting a primary arm mount 110 thereto. The flat mounting surface 136 provides four threaded apertures 138 for connecting the primary arm mount 110 thereto. A pair of apertures 140 are also provided on the flat mounting surface 136 for receiving dowel rods 142 on the primary arm mount 110, thereby properly positioning the primary arm mount 110 to the saddle mount 104. The flat mounting surfaces 136 of the saddle mounts 104 also provide throughbores 144 for receiving a primary arm 116 of the apparatus. The cap 132 of the saddle mount 104 may also be used as a mounting surface. The cap 132 is attached to the saddle mount 104 through the use of threaded fasteners, and apertures are provided on the cap 132 for receiving dowel rods for any fixturing that may be attached to the caps 132. The saddle mounts 104 are fabricated from a lightweight, high-strength material, similar to that provided for the backbone 102.

In order to extend the end effector tooling 22 from the saddle mounts 104, the primary arm mount 110 may be connected to one of the flat mounting surfaces 136 on the saddle mount 104. The primary arm mount 110 may provide the breakaway arm mount 112, as seen in FIGS. 9 and 13-14. The breakaway arm mount 112 has a substantially rectangular base portion 146, which is connected to the flat mounting surface 136 of the saddle mount 104 through the use of four threaded fasteners and the dowel rods 142, which utilize to properly locate and position the breakaway arm mount to the saddle mounts 104. A substantially cylindrical portion 148 of the breakaway arm mount 112 is integrally connected to the base portion 146. A narrowed neck portion 150 is provided between the base 146 and the cylindrical portion 148 of the breakaway arm mount 112 to provide a weakened portion of the breakaway arm mount 112. The cylindrical portion 148 of the breakaway arm mount 112 receives the primary arm 116, and the primary arm 116 abuts a shoulder within the cylindrical portion 148 of the breakaway arm mount 112. Thus, when the primary arm 116 realizes a lateral force that is beyond a predetermined limit, the neck portion 150 of the breakaway arm mount 112 will break, thereby preventing any damage to the remaining tooling. Thus, by simply replacing the breakaway arm mount 112, the apparatus 100 can be easily replaced at a minimum cost and time. The breakaway arm mount 112 is fabricated in a high-precision manner so as to maintain a high degree of accuracy when mounting the end effector tooling 22 thereon. The breakaway arm mount 112 may be fabricated from aluminum alloy or other lightweight, high-strength material. The cylinder portion 148 of the breakaway arm mount 112 may have a plurality of threaded apertures and non-threaded apertures for receiving threaded fasteners and dowel pins on the face of the cylinder portion 148 of the breakaway arm mount 112.

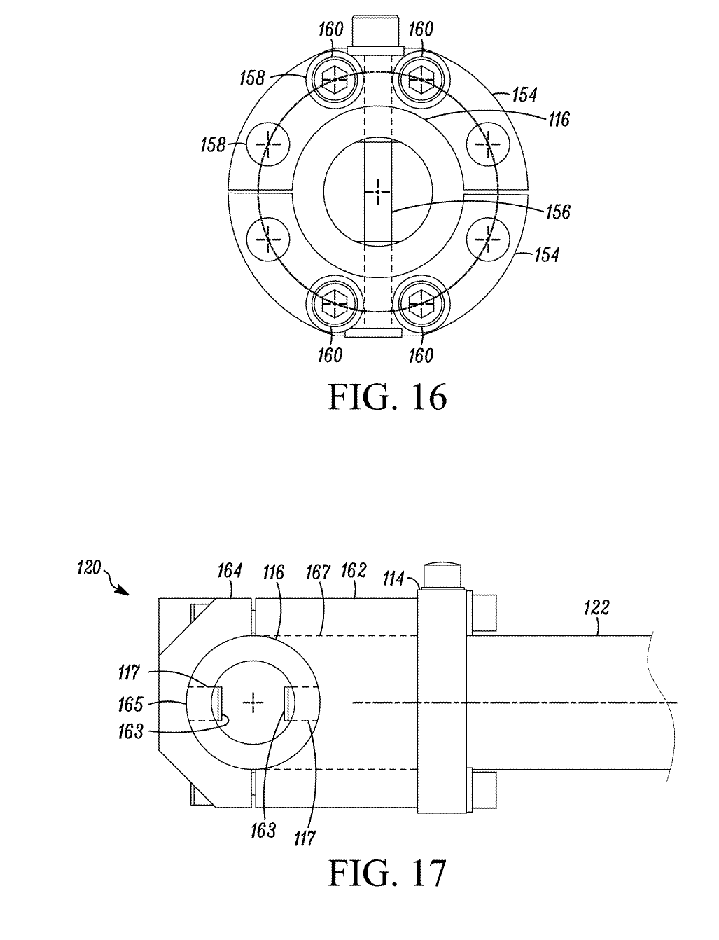

In order to provide rotational and axial movement of the primary arm 116, the primary arm mount 116 may also provide the lock ring 114 connected to the breakaway arm mount 112, as best seen in FIGS. 15-16. The lock ring 114 connects the primary arm 116 to the breakaway arm mount 112 by connecting a pair of substantially similar semi-cylindrical disc portions 154, wherein the two semi-cylindrical disc portions 154 form a substantially cylindrical disc when the two semi-cylindrical disc portions 154 are connected together. The semi-cylindrical disc portions 154 are connected by a fastener 156, which extends radially through the semi-cylindrical disc 154 of the lock ring 114. The fastener 156 also passes through a pair of apertures provided in the primary arm 116 so as to position and secure the primary arm in the lock ring 114. The lock ring 114 also has apertures 158, which extend axially through the lock ring 114. The apertures 158 are radially-spaced every 45° about the lock ring 114. Four fasteners 160 extend through the apertures 158 and the lock ring and secure the lock ring 114 to the breakaway arm mount 112. By rotating the lock ring 114 with respect to the breakaway arm mount 112 and moving the fasteners 160 to different apertures 158 in the lock ring 114, the primary arm 116 can be rotationally adjusted to a predetermined angle. In addition, the primary arm 116 can be adjusted along its longitudinal axis by inserting the fastener 156 into various apertures in the primary arm 116. Again, the lock ring 114 is fabricated in a high-precision manner so as to maintain a high degree of accuracy when mounting the end effector tooling 22 thereon. The lock ring 114 may be fabricated from a lightweight, high-strength material, such as alloy steel.

The primary arm 116 is also fabricated in a high-precision manner so as to maintain a high degree of accuracy when mounting the end effector tooling 22 thereon. The primary arm 116 is fabricated from a lightweight, high-strength steel, such as aluminum. The primary arm may have a plurality of apertures extending therethrough for receiving dowel pins in order to properly position the primary arm 116 with respect to the end effector tooling 22.

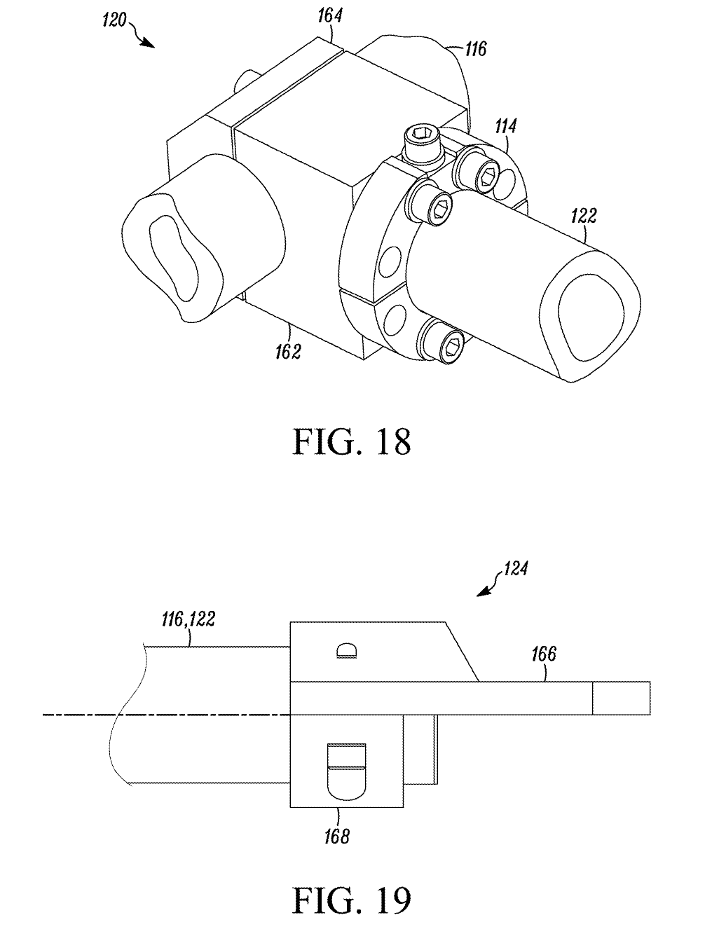

In order to connect the end effector tooling 22 to the primary arm 116, the tooling mount 118 may be connected to the primary arm 116. The tooling mount 118 may include the secondary arm mount 120, which has a substantially semi-circular portion 164 connected to the rectangular portion 162 of the secondary arm mount 120, as shown in FIGS. 17-18. The semi-circular portion 164 and the rectangular portion 162 cooperate to form a throughbore 165 between them for receiving the primary arm 116. Threaded fasteners are utilized to connect the semi-circular portion 164 to the rectangular portion 162 of the secondary arm mount 120. A dowel rod 163 extends from one or both of the semi-circular portion 164 and the rectangular portion 162 of the secondary arm mount 120 into the throughbore 165 formed by the semi-circular portion 164 and the rectangular portion 162 of the secondary arm mount 120 and is utilized to engage an aperture 117 in the primary arm 116 for locating and positioning the primary arm 116 in the secondary arm mount 120. The rectangular portion 162 of the secondary arm mount 120 also has a bore 167 having a longitudinal axis that is substantially perpendicular to a longitudinal axis of the throughbore 165 formed by the semi-circular portion 164 and the rectangular portion 162 of the secondary arm mount 120. The bore 167 in the rectangular portion 162 of the secondary arm mount 120 receives a secondary arm 122. A lock ring 114, as previously described, may be attached to a mounting surface on the rectangular portion 162 of the secondary arm mount 120 in order to properly position and secure the secondary arm 122 to the secondary arm mount 120. The secondary arm mount is also fabricated in a high-precision manner so as to maintain a high degree of accuracy when mounting the end effector tooling 22 thereon. The secondary arm mount 120 may be fabricated from a lightweight, high-strength material, such as an aluminum alloy.

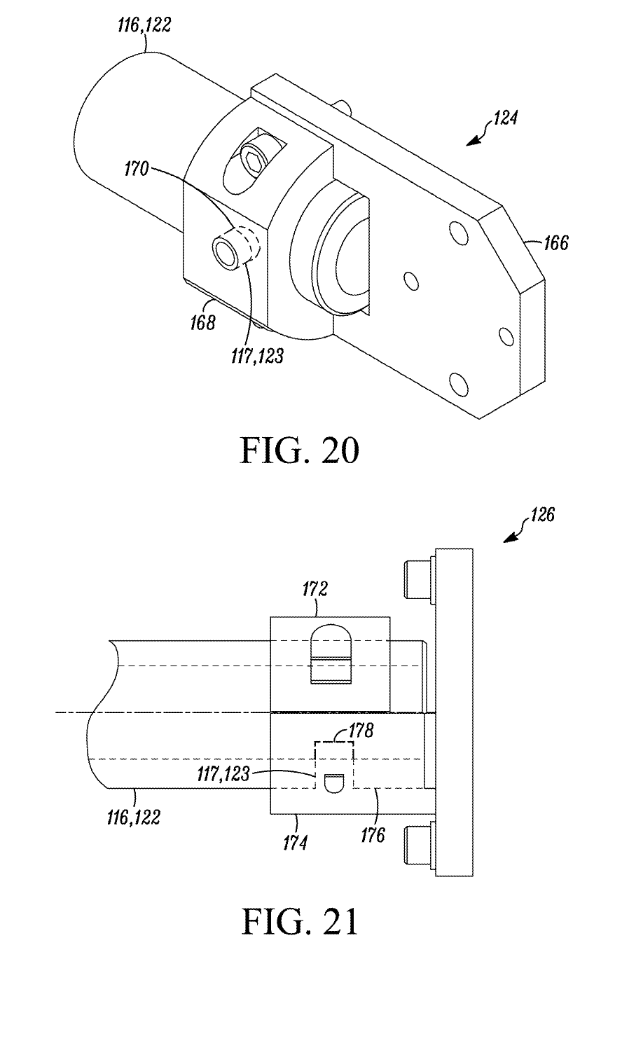

The tooling mount 118 may also provide the blade end mount 124 connected to the primary arm 116 or the secondary arm 122, as shown in FIGS. 19-20. The blade end mount 124 may provide a flat mounting portion 166 with a clamping portion 168 provided thereon. The clamping portion 168 has a semi-cylindrical portion, which attaches to the flat mounting portion 166 through the use of threaded fasteners. The clamping portion 168 and the flat mounting portion form a bore for receiving the primary arm 116 or secondary arm 122. A dowel rod 170 extends from the clamping portion 168 into the bore, thereby engaging one of the apertures 117 in the primary arm 116 or one of a plurality of apertures 123 in the secondary arm 122 for locating and positioning the primary arm 116 or the secondary arm 122 in the blade end mount. The flat mounting portion 166 of the blade end mount 124 provides threaded apertures and non-threaded apertures for receiving fasteners and dowel pins for attaching the end effector tooling 22 thereon. The blade end mounts 124 are fabricated in a high-precision manner so as to maintain a high degree of accuracy when mounting the end effector tooling 22 thereon. The blade end mount 124 may be fabricated from a lightweight, high-strength material, such as that described in connection with the backbone 102.

The tooling mount 118 may also include the end mount 126, as shown in FIGS. 21-23. The end mount 126 may have first and second semi-cylindrical clamping portions 172, 174, which form a bore 176 for receiving the primary arm 116 or the secondary arm 122. The two semi-cylindrical clamping portions 172, 174 may be connected to one another by threaded fasteners. A dowel pin may extend from one or both of the clamping portions 172, 174 into the bore 176 and are inserted into one of the apertures 117, 123 in the primary arm 116 or the secondary arm 122 for properly positioning and locating the primary arm 116 or secondary arm 122 in the end mount. A flat mounting surface 180 is connected to the second clamping portion 174 of the end mount 126, wherein the flat mounting surface 180 is perpendicular to longitudinal axis of the primary arm 116 or the secondary arm 122. The flat mounting surface 180 has a plurality of apertures 182 linearly aligned across the mounting surface 180 for receiving dowel pins of the end effector tooling 22. Slots 184 are provided on each end of the flat mounting surface for receiving threaded fasteners from the end effector tooling 22. Again, the end mounts 126 are fabricated in a high-precision manner so as to maintain a high degree of accuracy when mounting the end effector tooling 22 thereon. The end mounts 126 may be fabricated from a lightweight, high-strength material such as an aluminum alloy.

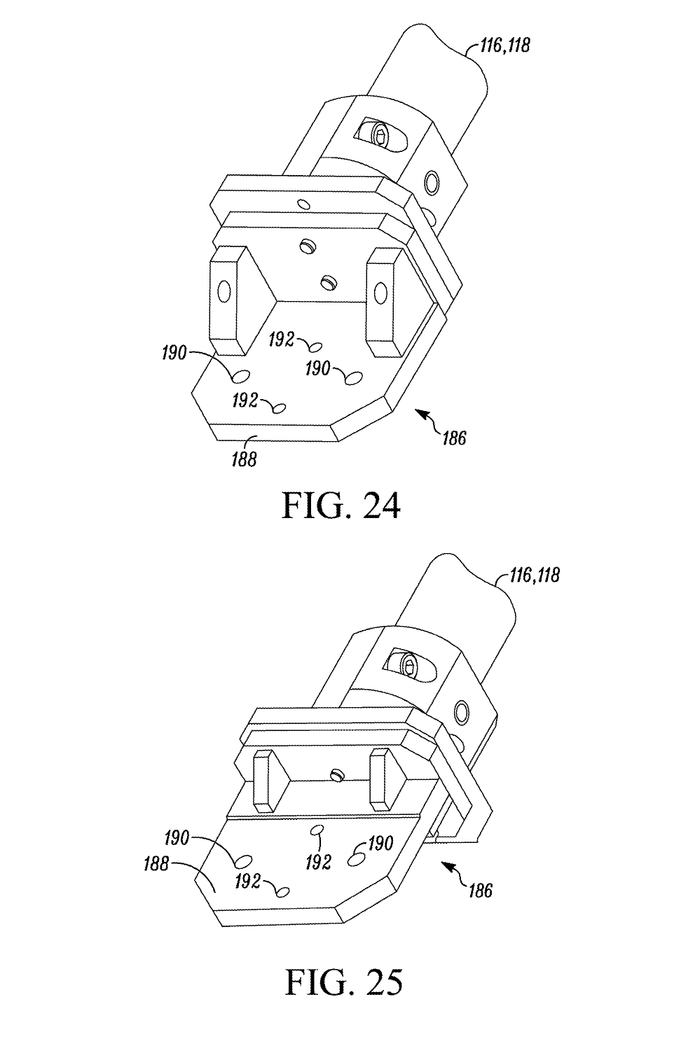

Various blade mounts 186 may be connected to the end mount 126. As seen in FIGS. 24-25, the blade mounts 186 may be connected to the end mounts 126 through the use of dowel rods and fasteners. The blade mounts 186 have a flat mounting surface 188 having a plurality of threaded apertures 190 and non-threaded apertures 192 for receiving fasteners and dowel pins from the end effector tooling 22.

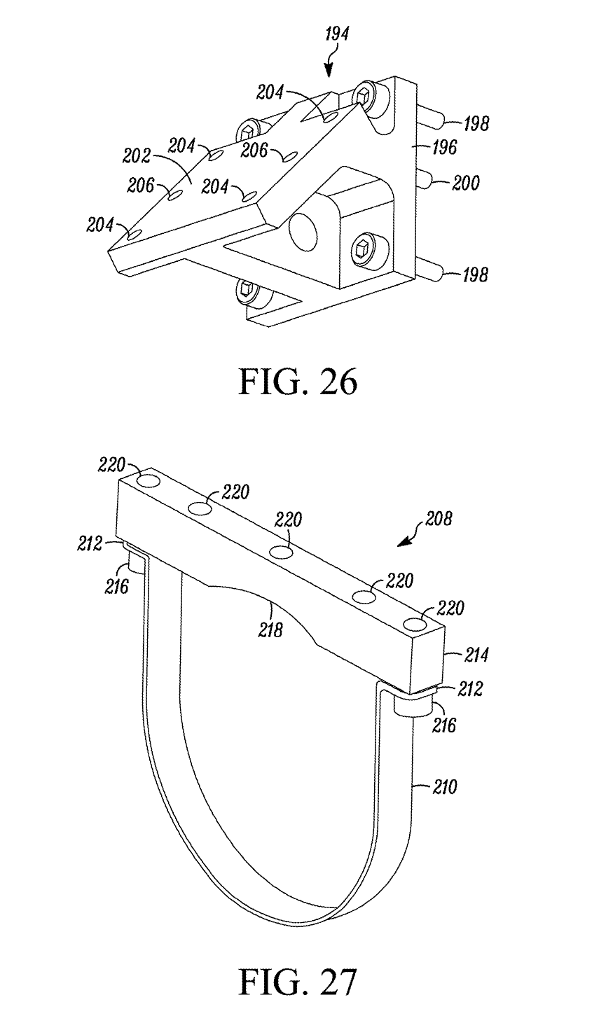

The tooling mounts 118 may also provide a transition mount 194 for mounting the end effector tooling 22 at a particular angle. The transition mount 194, as seen in FIG. 26, has a first flat mount surface 190 wherein threaded fasteners 198 and dowel pins 200 are utilized to connect the transition mount 194 to the adjacent tooling. A second substantially flat mounting surface 202 extends at an acute angle relative to the first flat mounting surface 196. The second flat mounting surface 202 provides threaded apertures 204 and non-threaded apertures 206 for receiving fasteners and the dowel pin of the end effector tooling 22.

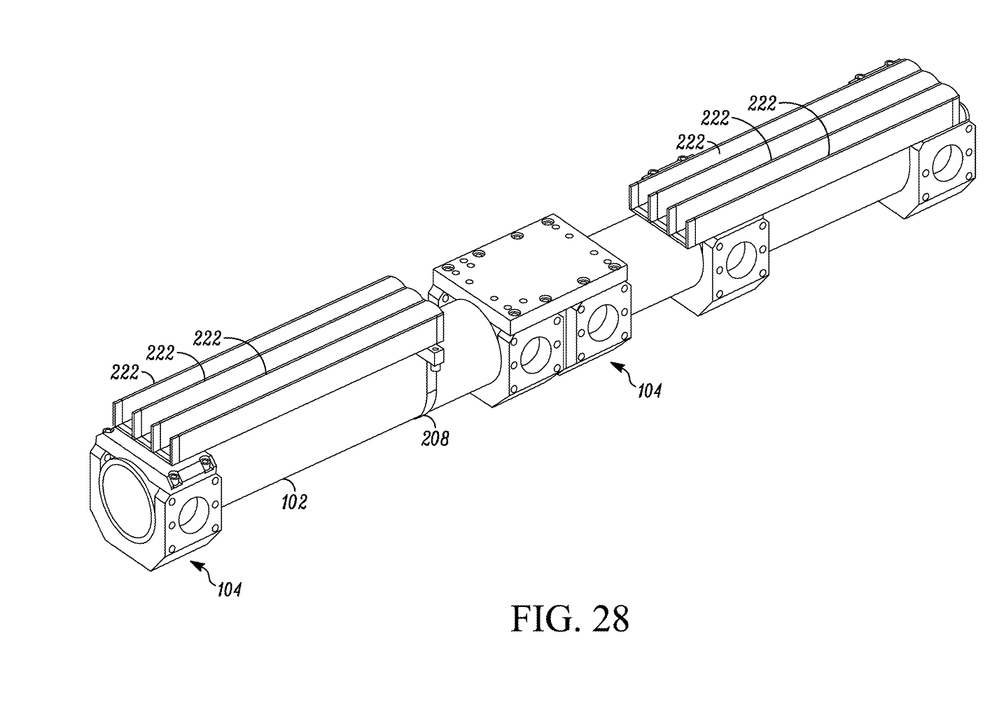

In order to organize and guide any wires, cables, or hoses that may be utilized in the apparatus 100 or to attach junction boxes and other equipment to the apparatus 100, an accessory clamp 208 may be connected to the backbone 102 or the primary arm 116 or the secondary arm 122, as shown in FIG. 27. The accessory clamp 208 has a flexible, metallic band 210 having a substantially U-shaped configuration, wherein the ends 212 of the U-shaped band 210 are connected to a bracket 214 through the use of a pair of fasteners 216. The bracket 214 has a substantially rectangular configuration with an arcuate recess 218 on the underside of the bracket 214 for receiving a cylindrical backbone 102 or the primary or secondary arm 116, 122. The bracket 214 has a plurality of threaded apertures 220 in the top surface of the bracket 214. As shown in FIG. 28, substantially rectangular cable trays 222 may be connected to the bracket 214 through the use of fasteners (not shown). The cable trays 222 are then utilized to house any wire and cables that are utilized on the apparatus 100.

In operation, the apparatus 100 is typically set up prior to connecting the apparatus 100 to a manipulator or a robotic arm. The end effector 22 is adjusted with respect to the apparatus 100 so as to provide proper geometric positioning of the workpiece 12. End effector tooling 22 may be adjusted by moving and/or adjusting the various primary arm mounts 122, second arm mounts 120, and tooling mounts 118 with respect to the backbone 102 and the saddle mounts 104. The length of the primary and secondary arms 116, 122 may also be adjusted to provide further adjustment to the end effector tooling 22. Various combinations of the saddle mounts 104, primary and secondary arm mounts 110, 120, and tooling mounts 118 may be utilized to give varied positions of the end effector tooling.

While the invention has been described in connection with what is presently considered to be the most practical and preferred embodiment, it is to be understood that the invention is not to be limited to the disclosed embodiments, but to the contrary, it is intended to cover various modifications or equivalent arrangements included within the spirit and scope of the appended claims. The scope is to be accorded the broadest interpretation so as to encompass all such modifications and equivalent structures as is performed under the law.

What is claimed is:

1. A tooling apparatus for securing and positioning end effector tooling with respect to a workpiece, comprising:
an elongated substantially cylindrical backbone connectable to a manipulator;
at least one saddle mount connected to said backbone;
at least one primary arm mount connected to said at least one saddle mount;
at least one substantially cylindrical primary arm connected to said at least one primary arm mount; and
at least one tooling mount connected to said at least one primary arm and connectable to said end effector tooling.

2. The tooling apparatus as stated in claim 1, further comprising:
said saddle mount have a substantially U-shaped configuration having a cap connected to and closing the open end of said U-shaped configuration, and said saddle mount having at least one mounting surface for attaching said at least one arm mount thereto;
said U-shaped configuration and said cap of said saddle mount forming a through bore for receiving and securing said backbone to said saddle mount; and
a dowel pin connected to said saddle mount and extending into said through bore and through an aperture in said backbone for properly locating and securing said backbone to said saddle mount.

3. The tooling apparatus as stated in claim 2, further comprising:
said cap of said saddle mount having a plurality of threaded apertures adaptable to mount tooling hardware to said cap.

4. The tooling apparatus as stated in claim 1, wherein said primary arm mount further comprises:
a breakaway arm mount connected to said primary arm wherein said breakaway arm mount has a weakened section such that said weakened section breaks upon realizing an impact to said primary arm that is greater than a predetermined level of force.

5. The tooling apparatus as stated in claim 1, wherein said primary arm mount further comprises:
a lock ring for connecting said at least one primary arm to said saddle mount wherein said lock ring provides radial and axial adjustment of said at least one primary arm.

6. The tooling apparatus as stated in claim 5, wherein said lock ring further comprises:
a pair of substantially similar semi-cylindrical disk connected together to form a bore extending there through for receiving said primary arm; and
a locating pin extending through said pair of semi-cylindrical disks and through a pair of apertures in said primary arm for properly locating and securing said primary arm to said pair of semi-cylindrical disks, and said locating pin having a longitudinal axis substantially perpendicular to said longitudinal axis of said primary arm.

7. The tooling apparatus as stated in claim 6, further comprising:
said pair of semi-cylindrical disks having a plurality of threaded apertures extending through said pair of semi-cylindrical disks, and said apertures having longitudinal axes that are substantially parallel to said longitudinal axis of said primary arm, and said plurality of threaded apertures allowing said pair of semi-cylindrical disks and said primary arm to be mounted in various rotational positions.

8. The tooling apparatus as stated in claim 1, wherein said arm mount further comprises:
a transition mount having a first substantially flat surface connected to said saddle mount, and a second substantially flat surface connected to said primary arm mount wherein said first surface and said second surface are at acute angles with respect to one another.

9. The tooling apparatus as stated in claim 1, said tooling mount further comprising:
a blade end mount having a pair of substantially similar semi-cylinders and a plate therebetween connected together to form a bore for receiving and securing said at least one primary arm to said blade end mount wherein a dowel rod extends from said blade end mount into said bore and through an aperture provided in said at least one primary arm for properly locating and securing said at least one primary arm to said blade mount; and
said plate of said blade end mount having a substantially flat mounting surface for mounting said end effector tooling substantially perpendicular to a longitudinal axis of said primary arm.

10. The tooling apparatus as stated in claim 1, said tooling mount further comprising:
an end mount having a pair of substantially similar semi-cylinders connected together to form a bore for receiving and securing said at least one primary arm wherein a dowel rod extends from said end mount into said bore and through an aperture provided in said at least one primary arm for properly locating and securing said at least one primary arm to said end mount; and
said end mount having a substantially planar surface connected to said pair of semi-cylinders and substantially perpendicular to said longitudinal axis of said primary arm for mounting said end effector tooling thereto.

11. The tooling apparatus as stated in claim 10, further comprising:
said substantially planar surface of said end mount having a plurality of adjacent apertures linearly aligned and a pair of slots extending there through; and
a blade mount having a plurality of apertures wherein dowel rods extend through said apertures of said blade mount and said end mount for accurately positioning and securing said blade mount to said end mount and threaded apertures for receiving threaded fasteners which extend through said slots in said end mount and into said threaded apertures to secure said blade mount to said end mount; and
said blade mount having a mounting surface for mounting said end effector tooling thereto.

12. The tooling apparatus as stated in claim 1, further comprising:
an accessory clamp having a flexible band formed in a substantially U-shaped configuration wherein the ends of said U-shaped configuration are connected to a bracket; and
said bracket having threaded apertures connectable to tooling hardware.

13. The tooling apparatus as stated in claim 11, further comprising:
a cable tray having a hollow substantially rectangular configuration connected to said bracket.

14. The tooling apparatus as stated in claim 1, wherein said tooling mount further comprises:
a secondary arm mount having a first though bore for receiving said at least one primary arm wherein a dowel pin extends from said secondary arm mount into said through bore and through an aperture in said primary arm to properly position and secure said primary arm to said secondary arm mount;
said secondary arm mount having a second through bore for receiving a secondary arm wherein a dowel pin extends from said secondary arm mount into said second through bore and through an aperture in said secondary arm to properly position and secure said secondary arm to said secondary arm mount; and
said secondary arm mount having a substantially flat mounting surface connectable to said end effector tooling.

15. A method for providing a tooling apparatus for securing and positioning end effector tooling with respect to a workpiece, comprising the steps of:
providing an elongated substantially cylindrical backbone adaptable to engage a manipulator;
connecting at least one saddle mount to said backbone;
connecting at least one primary arm mount to said at least one saddle mount;
connecting at least one primary substantially cylindrical arm to said primary arm mount; and
providing a tooling mount connected to said primary arm for supporting and positioning said end effector tooling.

16. The method as stated in claim 14, wherein said step of connecting said primary arm mount further comprises the steps of:
providing a breakaway arm mount having a weakened section that will break upon said primary arm realizing an impact greater than a predetermined force.

17. The method as stated in claim 14, wherein said step of connecting said primary arm mount further comprises the steps of:
providing a lock ring for connecting said at least one primary arm to said saddle mount and providing said radial and axial adjustment of said at least one primary arm.

18. The method as stated in claim 14, wherein said step of providing a tool mount further comprising the steps of:
providing a blade end mount having a bore and dowel pin for securing and positioning said primary arm thereto, and a mounting surface connectable to said end effector tooling.

19. The method as stated in claim 14, wherein said step of providing a tool mount further comprising the steps of:
providing an end mount having a bore and dowel pin for securing and positioning said primary arm thereto, and a substantially planar mounting surface substantially perpendicular to a longitudinal axis of said primary arm for connecting a blade mount thereto; and
providing a plurality of apertures substantially linearly aligned in said mounting surface for providing linear adjustment of said blade mount to said end mount.

20. The method as stated in claim 14, further comprising the steps of:
providing at least one accessory clamp having a flexible band formed in substantially U-shaped configuration for connecting said band to said backbone and said primary arm; and
providing a bracket connected to said band for connecting tooling hardware thereto.

21. The method as stated in claim 14, wherein said step of providing a tool mount further comprises:
providing a secondary arm mount having a first bore and first dowel pin for securing and positioning said primary arm in said secondary arm mount, and a second bore and dowel pin for securing and positioning a secondary arm substantially perpendicular to said primary arm.
